(19) United States
(12) Patent Application Publication
(10) Pub. No.: US 2003/0194523 A1
(43) Pub. Date: Oct. 16, 2003

(54) Pressure-sensitive adhesive identification label

(75) Inventors: Katsuya Kume, Ibaraki-shi (JP); Katsuyuki Okazaki, Ibaraki-shi (JP); Tsuneyuki Amano, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/413,548

(22) Filed: Apr. 15, 2003

(30) Foreign Application Priority Data
Apr. 16, 2002 (JP) P. 2002-113179

(51) Int. Cl. B32B 9/00

(52) U.S. Cl. 428/40.1; 428/354

(57) ABSTRACT

A pressure-sensitive adhesive identification label which involves little outgassing from a volatile silicone component, exhibits antistatic properties and is useful for application to a hard disk drive and its components comprises a substrate having a printable surface on one side thereof, a pressure-sensitive adhesive layer provided on the other side of the substrate, and an electrically conductive layer provided between the printable surface and the surface of the pressure-sensitive adhesive layer and has a volatile silicone component outgas level of 5 ng/cm² or less, with the conductive layer being at least one layer selected from an interlayer of the substrate, an interlayer of the pressure-sensitive adhesive layer, and a layer between the substrate and the pressure-sensitive adhesive layer, and being preferably substantially free from a halogen compound and/or a tin compound.

### FIELD OF THE INVENTION

This invention relates to a pressure-sensitive adhesive label for identification (ID label) which is free from a silicone component and has an antistatic function. More particularly, it pertains to a pressure-sensitive adhesive ID label that is useful for applications to a hard disk drive (HDD) and related components.

### BACKGROUND OF THE INVENTION

According as HDDs increase the recording density, the floating height of a recording head above a recording disk has ever been decreasing to as small as about 40 nm, which cannot be seen as a “floating height” and is now called “pseudo-contact”. It is expected that “contact” supplants pseudo-contact in a few years. HDD and related components manufactures are challenged to perfectly protect an HDD from contamination with a volatile silicone component which can cause reliability problems, such as head crashes.

Today, a pressure-sensitive adhesive ID label is stuck to an HDD and its components for furnishing product management information, such as the product number. Some pressure-sensitive adhesive labels contain a silicone compound in the pressure-sensitive adhesive of the pressure-sensitive adhesive layer, a release agent in the release liner protecting the pressure-sensitive adhesive layer, and the like. Even where the pressure-sensitive adhesive contains no silicone compound, the release liner, if its release side has been silicone treated, will contaminate the label (in particular, the pressure-sensitive adhesive layer) with the silicone compound. Where such a label is stuck to an HDD or its component, there is a very high possibility of the label allowing the volatile silicone component to enter the inside of the HDD.

In addition, the recording head of an HDD is prone to damage by static electricity. Therefore, labels used for management of components for HDD assembly, such as a recording head, are required to not only be silicone free (to involve little outgassing from a volatile silicone component) but have an antistatic function.

Furthermore, labels for this application is required to be free from a halogen compound in view of metal corrosion induced by halide ions (e.g., chloride ions). Freedom from a tin compound is also demanded because-of its metal corrosion.

JP-B-40-7673, JP-A-63-19244, JP-A-2-244599, JP-A-7-252456, JP-A-8-245932, and JP-A-2000-85068 disclose pressure-sensitive adhesive labels endowed with an antistatic function. (The term “JP-A” as used herein means an “unexamined published Japanese patent application”, and the term “JP-B” as used herein means an “examined Japanese patent publication”.) However, a pressure-sensitive adhesive label having an antistatic function and substantially free from any of a silicone compound, a halogen compound and a tin compound is unknown.

### SUMMARY OF THE INVENTION

An object of the present invention is to provide a pressure-sensitive adhesive ID label which involves no outgassing from a volatile silicone component and exhibits antistatic properties.

Another object of the invention is to provide a pressure-sensitive adhesive ID label useful as a pressure-sensitive adhesive label to be stuck to an HDD and its components.

Still another object of the invention is to provide a pressure-sensitive adhesive label for application to an HDD and its components which is free from a halogen compound and/or a tin compound that can adversely affect an HDD.

As a result of extensive investigation, the present inventors have developed a pressure-sensitive adhesive label which contains an electrically conductive layer between the printable surface and the surface of the pressure-sensitive adhesive layer and has a specific limited volatile silicone component outgas level. They have found that this label, when applied to an HDD, effectively exhibits a silicone free function and an antistatic function and does not cause adverse influences on the HDD.

The present invention provides a pressure-sensitive adhesive ID label comprising a substrate having a printable surface on one side thereof and a pressure-sensitive adhesive layer provided on the other side of the substrate, which has an electrically conductive layer (hereinafter simply referred to as a conductive layer) between the printable surface and the surface of the pressure-sensitive adhesive layer and has a volatile silicone component outgas level of 5 ng/cm² or less on heating at 120° C. for 10 minutes.

The conductive layer can be at least one layer selected from an interlayer of the substrate, an interlayer of the pressure-sensitive adhesive layer, and a layer between the substrate and the pressure-sensitive adhesive layer. It is preferred for the conductive layer to contain substantially no halogen compound and/or no tin compound. The pressure-sensitive adhesive label preferably has a reflectance of 50% or higher for light having a wavelength of 633 nm incident on the printable surface. The pressure-sensitive adhesive layer may be protected with a release liner containing no silicone-based release agent.

The pressure-sensitive adhesive ID label according to the present invention involves little outgassing of a volatile silicone component and exhibits antistatic properties. Therefore, it is useful as a pressure-sensitive adhesive label to be stuck to an HDD and its components. In addition, the label of the invention can be designed to be substantially free from a halogen compound and/or a tin compound which can corrode metal. Adverse influences on an HDD can thus be removed more securely.

### BRIEF DESCRIPTION OF THE ACCOMPANYING DRAWINGS

FIG. 1 is a schematic cross-section of an example of the pressure-sensitive adhesive ID label according to the invention.

FIG. 2 is a schematic cross-section of another example of the pressure-sensitive adhesive ID label according to the invention.

FIG. 3 is a schematic cross-section of still another example of the pressure-sensitive adhesive ID label according to the invention.

FIG. 4 is a schematic cross-section of an example of the pressure-sensitive adhesive ID label according to the invention which has an ink-receiving layer.

FIG. 5 is a schematic cross-section of an example of the pressure-sensitive adhesive ID label which has the substrate surface printed.

FIG. 6 shows the pressure-sensitive adhesive ID label of FIG. 1 the pressure-sensitive adhesive layer of which is protected with a release liner.

### DETAILED DESCRIPTION OF THE INVENTION

The pressure-sensitive adhesive ID label of the invention fundamentally comprises a substrate having a printable surface on one side thereof, a pressure-sensitive adhesive layer provided on the other side of the substrate, and a conductive layer provided between the printable surface and the surface of the pressure-sensitive adhesive layer. The conductive layer is provided between the printable surface and the pressure-sensitive adhesive layer surface and therefore not exposed to the outside. Accordingly, the label maintains both the essential labeling functions of furnishing ID information and adhering to an object to be labeled and additionally exhibits an effective antistatic function ascribed to the conductive layer.

It is important that the amount of the outgas from a volatile silicone component which generates on heating the pressure-sensitive adhesive label of the invention at 120° C. for 10 minutes is 5 ng/cm² or less, preferably 1 ng/cm² or less. As long as this volatile silicone component outgas is controlled to 5 ng/cm² or lower, vaporization of a volatile silicone component from the label stuck to an HDD or its components can be seen as insubstantial, and the label will not cause corrosion or malfunction of the HDD or the components. If the outgas generated from a volatile silicone component on heating at 120° C. for 10 minutes exceeds 5 ng/cm², vapor of a volatile silicone component from the label can seriously ruin long-term reliability of the HDD.

The volatile silicone component outgas can be measured as follows. A given size of a specimen cut out of a pressure-sensitive adhesive ID label is weighed and then heated at 120° C. for 10 minutes in a purge-and-trap (P&T) head-space sampler (HSS) to cold-trap generated organosilicone gas (volatile silicone component) at −120° C. The trapped component is analyzed by gas chromatography/mass spectrometry (GC/MS). The amount of silicone compound-related gas generated on 120° C. heating (e.g., tri- to hexamers of cyclic silicones) is calculated based on n-decane standards and converted to the amount of volatile silicone component outgas per unit area (ng/cm²).

The pressure-sensitive adhesive ID label of the invention preferably comprises a substrate substantially free from a silicone compound, a pressure-sensitive adhesive layer substantially free from a silicone compound, and a conductive layer substantially free from a silicone compound and has a printable surface. More specifically, it is preferred for each of the substrate, the pressure-sensitive adhesive layer, and the conductive layer to have a silicone compound content of 10 ppm or lower, particularly 1 ppm or lower, especially 0 ppm.

It is also preferred for the label of the invention to contain substantially no halogen compound or substantially no tin compound so as to avert corrosion of metallic components of an HDD and its components. More specifically, it is preferred for the label to have a halogen compound content or a tin compound content each of 10 ppm or lower, particularly 1 ppm or lower, especially 0 ppm. In other words, the substrate, the pressure-sensitive adhesive layer, and the conductive layer making up the label of the invention each preferably contain substantially no halogen compound nor a tin compound.

Substrates substantially free from a silicone compound include plastic substrates, paper, nonwoven fabric, and laminates thereof. The plastic substrates include films or sheets of various thermoplastic resins, such as polyolefin resins, e.g., high-density polyethylene, low-density polyethylene, linear low-density polyethylene, polypropylene, and poly-4-methylpentene-1; polyester resins, e.g., polyethylene terephthalate, polybutylene terephthalate, polyethylene naphthalate, and polybutylene terephthalate; styrene resins, e.g., polystyrene; polyamide resins, e.g., nylon; and polyimide resins. The substrate may have a single layer structure or a multilayer structure.

In the embodiment where the conductive layer is an interlayer of a substrate, the substrate can have a laminate structure of, for example, plastic film/conductive layer/plastic film.

The thickness of the substrate is arbitrarily selected from the range that does not impair handling properties, and the like, usually ranging from 5 to 500 μm, preferably 5 to 300 μm, still preferably 10 to 200 μm. The substrate may be subjected to surface treatment for improving anchoring effect for the pressure-sensitive adhesive layer or the conductive layer, such as a corona discharge treatment or coating with various primers.

The plastic film as a substrate may be used either as it is or as reinforced with a reinforcing material, such as a metal material, a heat-resistant plastic material, a paper material, a cloth material, a fibrous material (e.g., nonwoven fabric), or a wire.

The pressure-sensitive adhesive which can be used to form the pressure-sensitive adhesive layer, particularly the one substantially free from a silicone compound, includes various kinds. Pressure-sensitive adhesives substantially free from a silicone compound is preferred as a matter of course. Pressure-sensitive adhesives substantially free from a silicone compound include acrylic pressure-sensitive adhesives, rubber pressure-sensitive adhesives, polyester pressure-sensitive adhesives, and polyurethane pressure-sensitive adhesives. These pressure-sensitive adhesives can be used either individually or as a combination of two or more thereof.

The acrylic pressure-sensitive adhesives, that is, poly(meth)acrylic ester adhesives, comprise an acrylic polymer obtained by solution polymerization, emulsion polymerization or a like technique and contain, if desired, various additives such as crosslinking agents, tackifiers, softeners, antioxidants, fillers, and pigments. The acrylic polymer is prepared by copolymerizing a monomer mixture comprising at least one of alkyl (meth)acrylates usually having 1 to about 14 carbon atoms in the alkyl moiety thereof, such as butyl (meth)acrylate, 2-ethylhexyl (meth)acrylate, hexyl (meth)acrylate, octyl (meth)acrylate, isooctyl (meth)acrylate, nonyl (meth)acrylate, isononyl (meth) acrylate, isoamyl (meth)acrylate, lauryl (meth)acrylate, and isomyristyl (meth)acrylate, as a main monomer and, if desired, a copolymerizable modifying monomer(s), such as (meth)acrylic acid, 2-hydroxyethyl (meth)acrylate, (meth)acrylonitrile, vinyl acetate, N-vinyl-2-pyrrolidone, and styrene.

The rubber pressure-sensitive adhesives include those comprising natural rubber, styrene-butadiene rubber, polyisobutylene rubber or styrene-isoprene rubber. The polyester pressure-sensitive adhesives include those mainly comprising a polyester obtained by using, as an essential polyol component, an aliphatic carbonate diol (such as one obtained by the reaction between a diol compound, e.g., butanediol, and a carbonate compound, e.g., ethylene carbonate).

Of these pressure-sensitive adhesives preferred are acrylic ones in view of their durability. The pressure-sensitive adhesive may be of solution type or solventless type, including an emulsion type, a hot-melt type, and a UV-curing type.

The thickness of the pressure-sensitive adhesive layer is not particularly limited and usually ranges 1 to 500 μm, preferably 1 to 100 μm, still preferably 5 to 50 μm. A pressure-sensitive adhesive layer thinner than 1 μm tends to have insufficient adhesion, and one thicker than 500 μm is uneconomical.

The method of forming the pressure-sensitive adhesive layer is not particularly restricted. For example, the pressure-sensitive adhesive layer can be formed by applying a pressure-sensitive adhesive directly to the substrate or by transferring a dried pressure-sensitive adhesive layer separately formed on a separator onto the substrate. In the former method, the above-described conductive layer may be formed on the surface of substrate to which the pressure-sensitive adhesive layer is to be applied. In the latter method, a pressure-sensitive adhesive is applied to a separator and spread thereon by rolling (e.g., calendering), gravure coating, doctor blade coating, or like coating techniques. The pressure-sensitive adhesive layer on the separator is superposed on the substrate and transferred thereto. The above-described conductive layer may be formed on the surface of substrate to which the pressure-sensitive adhesive layer is to be transferred.

In the embodiment where the conductive layer is provided as an interayer of the pressure-sensitive adhesive layer, the pressure-sensitive adhesive layer is formed by, for example, applying a pressure-sensitive adhesive or a pressure-sensitive adhesive layer to a substrate by direct coating or transfer coating to form a first pressure-sensitive adhesive layer, forming a conductive layer on the first pressure-sensitive adhesive layer, and again applying a pressure-sensitive adhesive or a pressure-sensitive adhesive layer to the conductive layer by direct coating or transfer coating to form a second (outermost) pressure-sensitive adhesive layer. The two pressure-sensitive adhesive layers having the conductive layer therebetween will be referred to as a conductive layer-containing pressure-sensitive adhesive layer. Otherwise, a first pressure-sensitive adhesive layer that is to be stuck to an object is formed on a separator by direct coating or transfer coating, a conductive layer is then formed on the first pressure-sensitive adhesive layer, and a pressure-sensitive adhesive is again directly applied or transferred onto the conductive layer to form a second pressure-sensitive adhesive layer that is to be in contact with a substrate. Then, the stack of the layers, i.e., the conductive layer-containing pressure-sensitive adhesive layer is transferred to the substrate with the second pressure-sensitive adhesive layer facing the substrate.

The conductive layer serves for prevention of static electrification. The conductive layer includes a metal foil, a deposited metal layer, a layer formed by applying a dispersion of an electrically conductive filler in a binder. A conductive layer formed by combination of these techniques will also do. A halogen compound and a tin compound are categorized as conductive substances. However, it is desirable that the conductive layer be substantially free from a halogen compound or a tin compound. It is acceptable for the conductive layer to contain up to 10 ppm, preferably up to 1 ppm, of a halogen compound or a tin compound.

The material of the metal foil or the deposited metal layer includes aluminum, nickel, stainless steel, copper, gold, silver, iron, chromium, titanium, cobalt, molybdenum, platinum, tungsten, tantalum, niobium, palladium, solder alloys, and alloys of these metals. The metal materials can be used in the form of foil or a particulate or fibrous form. The metal materials can be used either individually or as a combination of two or more thereof. A conductive layer of metal foil or deposited metal is formed by, for example, laminating the surface on which a conductive layer is to be formed, such as the surface of the substrate, with a metal foil or depositing a metal layer on the surface by a usual vacuum thin film formation techniques, such as vacuum evaporation, using a particulate or fibrous metal source.

The conductive filler which can be used to form a conductive layer includes particulate or fibrous metals, such as copper, gold, silver, nickel, aluminum, stainless steel, iron, chromium, titanium, cobalt, molybdenum, platinum, tungsten, tantalum, niobium, palladium, solder alloys, and alloys of these metals, such as copper alloys; particulate or fibrous metal oxides, such as zinc oxide, indium oxide, titanium oxide, and titan black; particulate or fibrous carbon materials, such as acetylene black, Ketjen black, natural graphite, and artificial graphite; particulate or fibrous conductive polymers, such as polypyrrole, polyaniline, polyacetylene, polythiophene, polyphenylene vinylene, and polyacene; and particles coated with these conductive substances, such as copper or silver particles coated with a noble metal. These conductive fillers can be used either individually or as a combination of two or more thereof.

The binder in which the conductive filler is dispersed includes, but is not limited to, thermoplastic resins, such as polyester, polyamide, acrylic resins, and polyurethane, and radiation-curing resins (e.g., UV-curing resins), such as UV-curing acrylic resins. Preferred of them are thermoplastic resins which are soluble in organic solvents. A dispersion of the conductive filler in a thermoplastic resin solution in an organic solvent can easily be applied to the substrate followed by drying to form a conductive layer. It is preferred that the binder be substantially free from a silicone compound, a halogen compound or a tin compound. The above-recited binders can be used either individually or as a combination of two or more thereof.

The dispersion of the conductive filler in the binder is applied to a surface on which a conductive layer is to be formed, such as the surface of the substrate by any known and commonly employed coating methods, followed by drying to form a conductive layer. It is also possible to form a conductive layer on the surface by laminating with a film separately prepared from the dispersion of the conductive filler in the binder.

If necessary, various means for assisting adhesion may be employed. For example, a conductive layer may be formed via an adhesive.

It is preferred that the conductive layer be formed by lamination with a metal foil or by vacuum deposition of metal because the amount of impurities, such as impurity ions, which may be incorporated into the conductive layer can be controlled very low by contamination control on the raw material. A deposited aluminum layer is particularly preferred.

The thickness of the conductive layer is not particularly limited and is usually selected from a range of from about 0.01 to 10 μm, preferably 0.03 to 5 μm, still preferably 0.05 to 3 μm.

The conductive layer has a surface resistivity (JIS K8911) of 10¹⁰ Ω/sq. or less, preferably 10⁹ Ω/sq. or less.

As stated previously, one side of the substrate is a printable surface. The term “printable surface” as used herein is intended to include not only a surface which has printability with ink, etc. but has not yet been printed but a surface which has printability and has been printed with ink, etc.

The substrate may have an ink-receiving layer to provide a printable surface. That is, the “printable surface” includes the surface of the substrate to which ink, etc. is to be or has been applied directly and the surface of an ink-receiving layer, etc. to which ink, etc. is to be or has been applied. The ink-receiving layer provided on the substrate makes the label printable with various printers including thermal transfer printers, laser printers, and ink jet printers. In view of no limitation of printers, the pressure-sensitive adhesive ID label of the present invention can be said to be highly versatile. The ID label can be supplied either plain or pre-printed. The label in a plain format can be printed on demand over a necessary area anytime anywhere. For example, in a working site for labeling, a desired area of the label can be printed and stuck to an HDD or its components. A requisite number of labels can be printed, and the design can be changed freely, which is ideal for high-mix low-volume applications.

The ink-receiving layer is not particularly limited, and any known and commonly employed ink-receiving layers can be used. For example, the ink-receiving layer can be formed of thermoplastic resins, such as polyester resins, e.g., polyethylene terephthalate.

The printable surface of the pressure-sensitive adhesive ID label of the invention preferably has a reflectance of 50% or higher, particularly 55% or higher, especially 60% or higher, for light having a wavelength of 633 nm incident thereon. With this reflectance of the printable surface, information for management, such as a bar cord or a two-dimensional cord, printed on the label can easily be read out by irradiating the printed surface with light of 633 nm. (The term “the reflectance of the printable surface” as used herein means “the reflectance on the white background of printable surface”.)

To obtain the above-recited reflectance, an opaque film or a film having an opaque coat, e.g., a white coat, can be used as a substrate. A film with a white coat (white-coated film) is particularly suitable. Useful white-coated films include transparent, semi-transparent or opaque films having a white coat on their surface, particularly the surface on the printable surface side. The white coat can be provided according to known or commonly employed methods.

Thus, any of transparent substrates, semi-transparent substrates, and opaque substrates can be used in the invention. An appropriate coating treatment, such as white coating treatment, selected from known or commonly used coating techniques can be given to the selected substrate (particularly the printable surface side of the substrate) according to a desired reflectance of the printable surface.

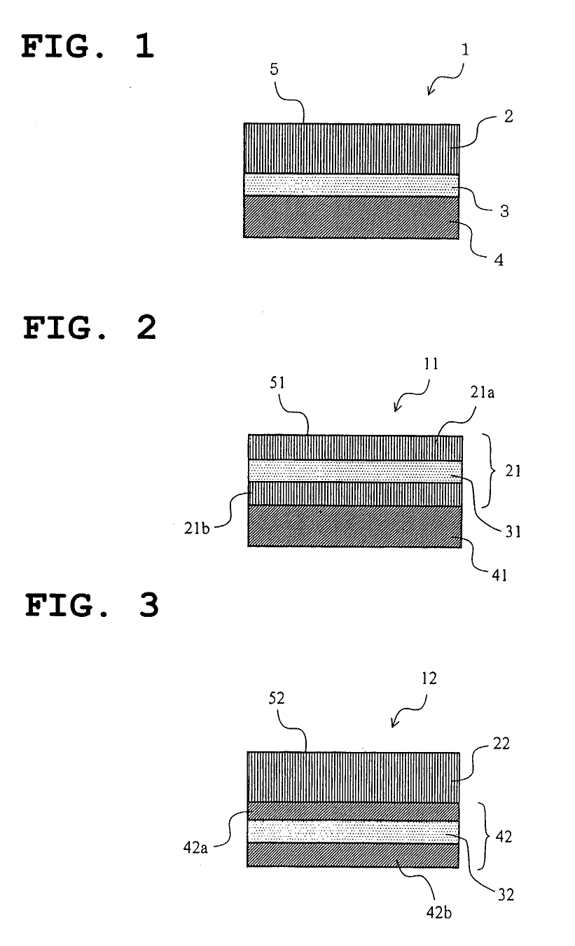

The pressure-sensitive adhesive ID label of the invention can have various layer configurations as long as it comprises the substrate with a printable surface on one side thereof, the pressure-sensitive adhesive layer on the other side of the substrate, and the conductive layer provided between the printable surface and the pressure-sensitive adhesive layer surface. Examples of the layer configurations are shown in FIGS. 1 to 3. The structure of FIG. 1 has a conductive layer between a substrate and a pressure-sensitive adhesive layer. The one shown in FIG. 2 has a conductive layer provided as an interlayer of a substrate. The one shown in FIG. 3 has a conductive layer as an interlayer of a pressure-sensitive adhesive layer.

More specifically, the label 1 of FIG. 1 has a substrate 2, a conductive layer 3 provided on the substrate 2, and a pressure-sensitive adhesive layer 4 provided on the conductive layer 3. The side of the substrate 2 opposite to the conductive layer 3 is a printable surface 5.

The label 11 of FIG. 2 consists of a substrate 21 containing a conductive layer 31 as an interlayer and a pressure-sensitive adhesive layer 41 provided on one side of the substrate 21. The other side of the substrate 21 is a printable surface 51. The substrate 21 containing the conductive layer 31 as an interlayer consists of a substrate layer 21a on the printable surface 51 side, the conductive layer 31 formed on the layer 21a, and a substrate layer 21b formed on the conductive layer 31 (on the pressure-sensitive adhesive layer 41 side).

The label 12 shown in FIG. 3 consists of a substrate 22 with a printable surface 52 on one side thereof and a pressure-sensitive adhesive layer 42 provided on the other side of the substrate 22. The pressure-sensitive adhesive layer 42 contains a conductive layer 32 as an interlayer. The pressure-sensitive adhesive layer 42 containing the conductive layer 32 as an interlayer is made up of a pressure-sensitive adhesive layer 42a on the substrate 22 side, the conductive layer 32 formed on the pressure-sensitive adhesive layer 42a, and a pressure-sensitive adhesive layer 42b formed on the conductive layer 32 (on the side of an adherent).

While the structures of FIGS. 1 through 3 have only one conductive layer, they may have more than one conductive layers. In other words, the label can have one or more conductive layers selected a conductive layer provided between the substrate and the pressure-sensitive adhesive layer, a conductive layer provided as an interlayer of the substrate, and a conductive layer provided as an interlayer of the pressure-sensitive adhesive layer.

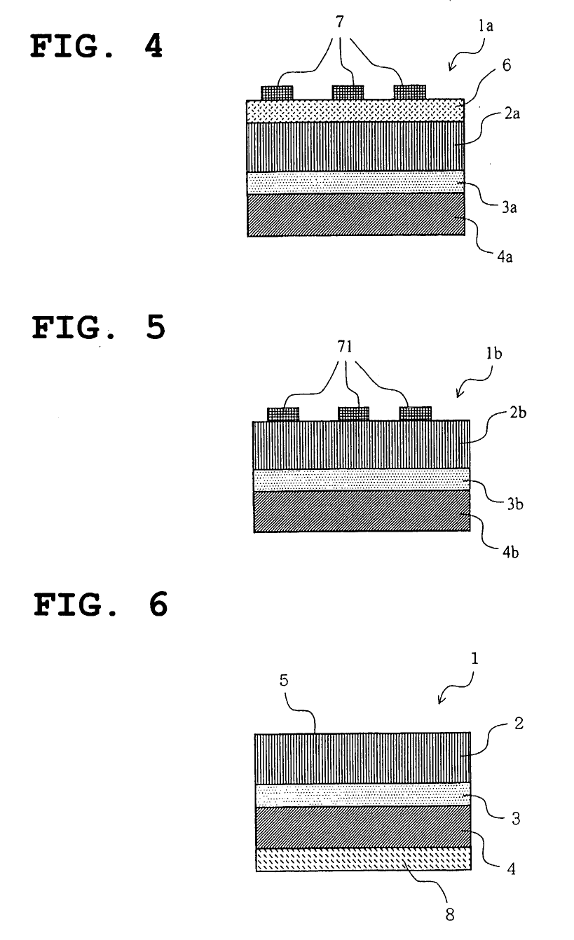

The pressure-sensitive adhesive ID label of the invention may have an ink-receiving layer on the printable side as previously mentioned. Where, for instance, the label has a substrate (containing no conductive layer as an interlayer), a conductive layer provided on the substrate, and a pressure-sensitive adhesive layer (containing no conductive layer as an interlayer) provided on the conductive layer, printing may be done on an ink-receiving layer provided on the printable side of the substrate as shown in FIG. 4 or practicable directly on the substrate as shown in FIG. 5.

The label la of FIG. 4 consists of a substrate 2a, an ink-receiving layer 6 on one side of the substrate 2a, a conductive layer 3a on the other side of the substrate, and a pressure-sensitive adhesive layer 4a on the conductive layer 3a, with an ink layer 7 printed on the ink-receiving layer 6. In FIG. 4 the ink layer 7 is depicted as an independent layer for the sake of distinction. The ink may penetrate the ink-receiving layer 6.

The label 1b of FIG. 5 consists of a substrate 2b with a printable surface on one side thereof, a conductive layer 3b on the other side of the substrate 2b, and a pressure-sensitive adhesive layer 4b on the conductive layer 3b, with an ink layer 71 printed directly on the printable surface of the substrate 2b.

The pressure-sensitive adhesive layer of the label may be protected with a release liner. FIG. 6 illustrates an example of layer configurations having such a release liner, wherein the same label 1 as in FIG. 1, which is fabricated of the substrate 2 (containing no conductive layer as an interlayer), the conductive layer 3 on the substrate 2, and a pressure-sensitive adhesive layer (containing no conductive layer as an interlayer) 4 on the conductive layer 3, has a release liner 8 provided on the pressure-sensitive adhesive layer 4.

Where the pressure-sensitive adhesive ID label is a linerless label with its pressure-sensitive adhesive layer not protected with a release liner, the printable surface of the label can be designed to have a release function as well as printability. Such a linerless pressure-sensitive adhesive label can be supplied in the form a stack of cut sheets or a roll of continuous length with the pressure-sensitive adhesive layer facing the releasable and printable surface.

The release liner, if provided, is not particularly limited but is preferably selected from those containing no silicone release agent for averting contamination with silicone. Such silicone-free release liners include those having a substrate and a release layer comprising a release agent other than silicone release agents, such as fluorine-containing release agents and long-chain alkyl type release agents; films of plastics which per se exhibit high releasability, such as polyolefins (e.g., polyethylene including linear low-density polyethylene and an ethylene-α-olefin copolymer) and Teflon®; and those prepared by laminating or coating a substrate (e.g., a metal foil or a heat-resistant plastic film) with the above-recited plastics having high releasability (e.g., polyolefins (e.g., polyethylene and ethylene-a-olefin copolymers), and Teflon) by known or commonly used laminating or coating techniques, such as heat lamination or extrusion coating with a molten resin.

The polyolefin film or Teflon film as a release liner preferably has a surface energy of 40 dyne/cm² or less.

If desired, the pressure-sensitive adhesive ID label of the invention may further has other layers in addition to the substrate, the conductive layer, and the pressure-sensitive adhesive layer.

Since the materials constituting the pressure-sensitive adhesive ID label of the invention are free from silicone compounds, outgassing of a volatile silicone component from the label is effectively avoided. Besides, the conductive layer makes the label exhibit excellent antistatic properties. Thus, the label of the invention is suited for application to sites or places where existence of a silicone compound is prohibited and to components liable to be destroyed by static electricity. The label of the invention is therefore useful for application to an HDD and its components. The label of the invention can be designed to be substantially free from a halogen compound and/or a tin compound. The label so designed is extremely useful as a label on an HDD and its components in view of preventing adverse influences of a halogen compound and/or a tin compound on the HDD and the components.

The HDD constituent components and HDD-related members, to which the label of the invention is applicable, include a recording head, a recording disk, a motor component, a flexible printed circuit, and trays for carrying these components.

In these applications, the pressure-sensitive adhesive ID label can be stuck to the outer surface of an HDD and the outer surface of the HDD components for the purpose of furnishing information for product management, such as bar codes and two-dimensional codes, or for commercial distribution, such as trade names. The labels of the invention are useful as management labels for production management, production process management, inspection management, component management, and the like and as trade name labels.

The present invention will now be illustrated in greater detail with reference to Examples, but it should be understood that the invention is not limited thereto. Unless otherwise noted, all the parts and percents are given by weight.

### EXAMPLE 1

A 50 μm thick polyester film having a white coat on one side thereof was used as a substrate. Aluminum was deposited on the other side of the substrate to form a conductive layer having a thickness of 50 nm (500 Å). A toluene solution containing 100 parts of an acrylic pressure-sensitive adhesive (acrylic resin having a weight average molecular weight of 300,000) and 3 parts of an isocyanate crosslinking agent (Coronate L, available from Nippon Polyurethane Industry Co., Ltd.) was applied uniformly to the conductive layer with a doctor blade and dried to form a 30 μm thick pressure-sensitive adhesive layer. A separator film (release liner) made of a polyolefin resin (polyethylene having a density of 0.94 g/cm³ or lower) was applied to the pressure-sensitive adhesive layer to prepare a pressure-sensitive adhesive label completely free from a silicone compound.

The resulting silicone-free pressure-sensitive adhesive label was punched to size and printed with a bar code on a thermal transfer printer in an isolated, silicone compound-free environment to prepare management labels for an HDD motor.

The release liner was peeled off the label, and the polyester film substrate was picked up with grounded tweezers. The quantity of static electricity of the label at this time was 30 V or less.

### EXAMPLE 2

A 25 μm thick transparent polyester film having on one side thereof a 0.5 μm thick ink-receiving layer made of a dispersion of titanium dioxide in an acrylic binder was used as a substrate. An aluminum was deposited on the other side of the substrate to form a 20 nm (200 Å) thick conductive layer. A silicone-free pressure-sensitive adhesive label was prepared in otherwise the same way as in Example 1. The resulting label was printed in the same manner as in Example 1 to prepare an HDD motor management label.

### EXAMPLE 3

A silicone-free pressure-sensitive adhesive label was prepared in the same way as in Example 1, except that an acrylic binder solution containing 30% of carbon particles was applied to the substrate to form a conductive layer having a thickness of 10 μm in place of the aluminum deposit layer. The resulting label was printed in the same way as in Example 1 to prepare an HDD motor management label.

### EXAMPLE 4

A silicone-free pressure-sensitive adhesive label was prepared in the same manner as in Example 1, except for using a long-chain alkyl-treated polyester film as a release liner. The resulting label was printed in the same way as in Example 1 to prepare an HDD motor management label.

### EXAMPLE 5

A silicone-free pressure-sensitive adhesive label was prepared in the same manner as in Example 1, except for replacing the aluminum deposit layer with a conductive layer made of a quaternary ammonium salt antistatic agent Bondip, available from Altech Co., Ltd. The resulting label was printed in the same way as in Example 1 to prepare an HDD motor management label.

### COMPARATVE EXAMPLE 1

A pressure-sensitive adhesive label was prepared in the same manner as in Example 1, except for using a silicone-treated polyethylene terephthalate film as a release liner. The resulting label was printed in the same way as in Example 1 to prepare an HDD motor management label.

### COMPARATIVE EXAMPLE 2

A silicone-free pressure-sensitive adhesive label was prepared in the same manner as in Example 1, except that the pressure-sensitive adhesive layer was formed on the side of the polyester film opposite to the aluminum deposit layer (conductive layer). The resulting label was printed in the same way as in Example 1 to prepare an HDD motor management label.

### COMPARATIVE EXAMPLE 3

A silicone-free pressure-sensitive adhesive label was prepared in the same manner as in Example 1, except that the aluminum deposit layer (conductive layer) was not formed. The resulting label was printed in the same way as in Example 1 to prepare an HDD motor management label. Evaluation:

The pressure-sensitive adhesive ID labels prepared in Examples and Comparative Examples were evaluated as follows. The results obtained are shown in Table 1.

(1) Printability

Reliability of the bar code pattern printed on the label by thermal transfer was evaluated with a barcode verifier, AUTO SCAN II supplied by RJS Electronics Inc.

(2) Reflectance

The reflectance (%) of the white background of the bar code-printed side at a wavelength of 633 nm was measured with AUTO SCAN II.

(3) Antistatic Properties

The pressure-sensitive adhesive ID label was cut into a sheet of 50 mm in width and 150 mm in length. The release liner was peeled off the sheet by a high-speed tensile tester at an angle of 180° at a speed of 1 m/min in an atmosphere of 25° C. and 65% RH. The amount of static electricity (V) generated on peeling was measured with a surface potentiometer, Electrostatic Voltmeter supplied by Trek Japan, in terms of surface potential on three points of the pressure-sensitive adhesive layer. The distance of the probe from the pressure-sensitive adhesive layer was set at about 3.5 mm. The measured values (V) are absolute values.

(4) Detection of Organosilicone

The pressure-sensitive adhesive label was heated at 120° C. for 10 minutes and the generated organosilicone outgas (volatile silicone component) was cold-trapped at −120° C. in a P&T head-space sampler. The trapped component was analyzed by GC/MS. The amount of the silicone compound outgas generated on 120° C. heating (e.g., tri- to hexamers of cyclic silicones) was calculated based on n-decane standards and converted to the amount of volatile silicone component outgas per unit area (ng/cm²).

(5) Detection of Total Halide Ions

The pressure-sensitive adhesive label was boiled in water at 100° C. for 45 minutes. The extract was analyzed for halide ion concentration with an ion chromatograph, DX-500 supplied by Dionex Corp.

TABLE 1

| | | | | | | Comparative | | |
|---|---|---|---|---|---|---|---|---|
| | Example | | | | | Example | | |
| | 1 | 2 | 3 | 4 | 5 | 1 | 2 | 3 |
| Printability | good | good | good | good | good | good | bad | good |
| Reflectance | 75 | 80 | 55 | 75 | 75 | 75 | 30 | 75 |
| (%) | | | | | | | | |
| Amount of | ≦30 | ≦30 | ≦30 | ≦30 | ≦30 | ≦30 | ≦30 | ≧100 |
| Static | | | | | | | | |
| Electricity (V) | | | | | | | | |
| Organo- | ≦1 | ≦1 | ≦1 | ≦1 | ≦1 | ≧10 | ≦1 | ≦1 |
| silicone | | | | | | | | |
| Outgas | | | | | | | | |
| (ng/cm²) | | | | | | | | |
| Extracted | ≦10 | ≦10 | ≦10 | ≦10 | ≧10 | ≦10 | ≦10 | ≦10 |
| Total Halide | | | | | | | | |
| Ion (μg/g) | | | | | | | | |

As is apparent from the results in Table 1, the pressure-sensitive adhesive labels of Examples 1 to 5 have satisfactory printability when printed with a bar code by thermal transfer and high reflectances at 633 nm on their white background. Accordingly, the bar code printed on these labels is easily read out with a conventional bar code scanner. The labels of Examples 1 to 5 generate only small quantity of static electricity on peeling the release liner, proving excellent in antistatic properties. The labels of Examples 1 to 5 are prevented from generating volatile silicone component outgas and have extremely small contents of a halogen compound and/or a tin compound. Therefore, where the labels of the present invention are applied to an HDD and its components, no adverse influences are exerted on the HDD.

While the present invention has been described in detail and with reference to specific embodiments thereof, it will be apparent to one skilled in the art that various changes and modifications can be made therein without departing from the spirit and the scope thereof.

What is claimed is:

1. A pressure-sensitive adhesive identification label comprising a substrate having a printable surface on one side thereof and a pressure-sensitive adhesive layer provided on the other side of the substrate, which has an electrically conductive layer between the printable surface and the surface of the pressure-sensitive adhesive layer and has a volatile silicone component outgas level of 5 ng/cm² or less on heating at 120° C. for 10 minutes.

2. The pressure-sensitive adhesive identification label according to claim 1, wherein said conductive layer is at least one layer selected from an interlayer of the substrate, an interlayer of the pressure-sensitive adhesive layer, and a layer between the substrate and the pressure-sensitive adhesive layer.

3. The pressure-sensitive adhesive identification label according to claim 1, wherein said conductive layer is substantially free from at least one of a halogen compound and a tin compound.

4. The pressure-sensitive adhesive identification label according to claim 1, wherein said printable surface has a reflectance of 50% or higher for light having a wavelength of 633 nm incident thereon.

5. The pressure-sensitive adhesive identification label according to claim 1, wherein said pressure-sensitive adhesive layer is protected with a release liner containing no silicone-based release agent.

6. The pressure-sensitive adhesive identification label according to claim 1, which is for application to a hard disk drive and components thereof.
